(19) United States
(12) Patent Application Publication
(10) Pub. No.: US 2006/0196366 A1
(43) Pub. Date: Sep. 7, 2006

(54) Cooking appliance condenser

(75) Inventor: Pierre Jeuch, Saint Aubin (FR)

Correspondence Address: SUGHRUE MION, PLLC, 2100 PENNSYLVANIA AVENUE, N.W., SUITE 800, WASHINGTON, DC, 20037, US

(73) Assignee: THERMAGEN, SA, Gif sur Yvette (FR)

(21) Appl. No.: 10/560,245

(22) PCT Filed: Jun. 11, 2004
(86) PCT No.: PCT/FR04/01461

§ 371 Date: Jan. 4, 2006

(30) Foreign Application Priority Data
Jun. 12, 2003 (FR) 03/07054

(51) Int. Cl. A47J 37/12

(52) U.S. Cl. 99/403

(57) ABSTRACT

The invention relates to a cooking appliance (1) comprising a condenser (23) for water vapour (V) generated by cooking and a water evaporator (24) for cooling said condenser. In such a way, the inventive appliance is provided with a device for condensing cooking vapours by cooling a condensation surface by means of water vaporisation. Said invention can be used for deep fryers.

The present invention relates to cooking appliances, such as for example deep fryers for domestic use.

Such appliances comprise a cooking vat placed in a casing closed by a lid during the cooking phase.

During the cooking, in particular frying, a large quantity of water is evaporated, producing a lot of cooking vapour. For example, in the case of frozen fries, more than 30% by mass of raw fries is transformed into steam. This steam is also loaded with particles of oil which produce the characteristic frying odour, which is generally considered to be undesirable.

In order to overcome the problem of undesirable odours, the manufacturers of deep fryers have used filter systems which allow the steam to pass through and retain the particles of oil. These filters however are not completely effective. The volume of vapour to be filtered is large, more than 500 litres of steam are released per 1 kg of fries.

In order to overcome this drawback, completely impermeable cooking appliances equipped with a condenser have been proposed. All of the steam generated by the cooking is condensed inside the appliance by means of a surface cooled for this purpose.

Such an appliance is known from the document WO 94/23626. The condenser is constituted by two water cartridges which are previously frozen and arranged to form a condensation channel for the cooking vapours released by the cooking vat, a condensate container being arranged at the end of this channel.

However this solution requires freezing the condensation cartridges. Moreover the efficiency of the heat transfer between the mass of frozen water and the surface where the condensation takes place is limited. It is therefore essential to combine this partial condensation solution with a standard filter for the cooking vapours.

A cooking appliance equipped with a condenser constituted by a surface cooled by convection in the outside air is also known from the document US 2003/0029323 A1. However, even with a heat exchanger with fins, this solution requires a substantial air flow in order to evacuate the energy produced by the condensation, taking into account the low heat capacity of the air.

The energy to be evacuated by the condenser is 2.5 kJ per gram of condensed water. In order to condense 300 g of steam in 5 minutes, an evacuating energy of 2.5 kW is therefore required. Using air convection as a cooling vector, assuming that the heat capacity of the air is 1 J/g and that one gram of air corresponds to a volume of one litre, an air flow of 200 m³/h is required in order to carry out the condensation of the 300 g of water in 5 minutes. This requires the use of a large fan which is bulky and noisy.

The present invention aims to resolve the drawbacks of the prior art and proposes a device allowing the condensation of the cooking vapours by cooling a condensation surface by means of the evaporation of water.

The invention relates more precisely to a cooking appliance comprising:

a condenser for the steam generated by cooking;

a water evaporator which is able to cool the condenser.

According to one embodiment, the appliance comprises a water container which is able to moisten the evaporator.

According to one characteristic, the appliance comprises a condensation container.

According to one embodiment, the evaporator evaporates the water condensed by the condenser.

According to one embodiment, the appliance comprises a porous support, a first face of the support comprising the condenser and a second face of the support comprising the evaporator.

According to one characteristic, the porous support is able to transport the water by capillary action from the first face to the second face.

According to one characteristic, the support comprises a metal part.

According to the embodiments, the metal part of the porous support is made of aluminium or sintered metal.

According to one characteristic, the metal part of the porous support comprises cells constituted by microperforations.

According to one embodiment, the support comprises a metal grid.

According to one characteristic, the support comprises a porous hydrophilic layer.

According to one characteristic, the support also comprises a fan.

According to one characteristic, the appliance also comprises a pressure relief valve.

According to one characteristic, the support also comprises a filter.

The features and advantages of the present invention will be better understood using the following description which is given as illustrative and non-limitative example, and with reference to the attached figures which show:

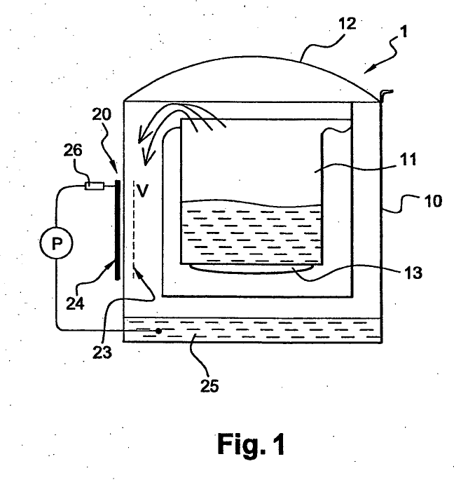

FIG. 1, a diagrammatic view of a cooking appliance according to the invention;

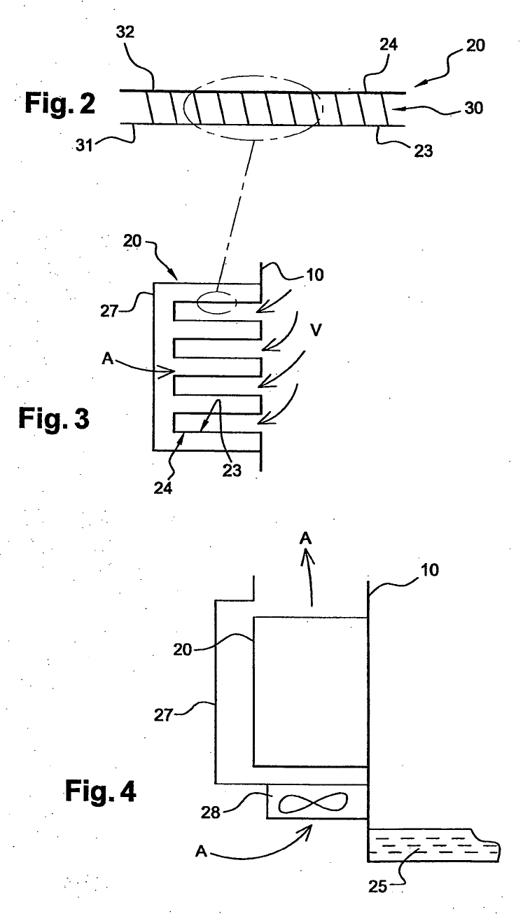

FIG. 2, a diagram of the condenser/evaporator according to one embodiment of the invention;

FIG. 3, a diagram of the arrangement of the condenser/evaporator of FIG. 2 in a top view;

FIG. 4, a diagram of the arrangement of the condenser/evaporator of FIG. 2 in a side view.

According to the invention, a condenser is arranged in a cooking appliance in order to condense almost all of the vapours released by cooking. The condensation surface is cooled by the evaporation of water. The high latent heat of evaporation of the water allows good cooling efficiency to be ensured.

Thus, in order to condense 300 g of steams it is sufficient to evaporate 300 g of water. Steam will therefore be released from the condensation device of the cooking appliance according to the invention, but this vapour will come from an evaporator and not from cooking and will not be loaded with undesirable particles, such as particles of oil.

With reference to FIG. 1, a cooking appliance 1 comprises a cooking vat 11 heated by an element 13 and arranged in a casing 10 closed by a lid 12. During cooking, vapours V are released by the vat 11, essentially steam.

A device 20 for the condensation of this steam is arranged inside the appliance, on a side face of the casing or in the lid.

The condensation device comprises a condenser, i.e. a cold surface 23, inside the appliance, on which the steam V released by cooking condenses in order to form drops of water, optionally loaded with oil in the case of a deep fryer. The vapour condensate can be recovered in a condensation container 25.

The condensation device also comprises an evaporator, i.e. a cooling surface 24 on which water evaporates. The surface of the evaporator 24 is arranged in order to cool the condensation surface 23. The evaporator comprises a container 26 for water which is to be evaporated arranged in order to moisten the cooling surface 24. The container can be integrated in the appliance. The latent heat of evaporation of the water is 2.5 kJ/g, and one gram of water represents a volume of 1 ml. The evaporator container therefore contains only 300 ml of water.

The evaporation container 26 can also communicate with the condensation container 25 and use some of the condensed water for the evaporation. The condensed water is then filtered and pumped in order to be evaporated on the external cooling surface 24.

According to one embodiment, an illustration of which is given in FIG. 2, the condensation device 20 comprises a support 30 made of porous material. A first face 31 of the support constitutes the condensation face 23 and a second face 32 constitutes the evaporation surface 24.

The evaporation surface 24 can be covered with a porous hydrophilic layer ensuring that the evaporation surface is always well moistened in order to guarantee evaporation of water and good cooling of the condensation surface 23.

The support 30 can be a porous and hydrophilic metal part, such as a part made of aluminium for example pierced with microperforations (of the order of 2- 3/10 mm) creating cells or a sintered metal part.

The metal of the support 30 allows a good heat conduction between the internal (to be cooled) and external (cooling) surfaces; and the porosity of the material of the support 30 allows a capillary drainage between the condensation surface 23 and the evaporation surface 24. The porosity of the material of the support 30 is such that the molecules of water pass through the support, absorbed by the hydrophilic layer of the evaporation surface 24, but the particles of oil are retained in the cooking appliance by the porous part 30 which serves as a filter.

The presence of a container 26 and a condensation container 25 is therefore not essential, the evaporator 24 being able to be directly moisten by capillary action with the water condensed on the condensation surface 23.

This metal support part 30 can advantageously by removed from the appliance and washed in a dish-washer for example in order to eliminate the particles of oil adhering to this support.

The support 30 can also be constituted by a metal support grid combined with a filter paper arranged on the side of the condensation surface 23, i.e. on the side of the overpressure.

FIGS. 3 and 4 illustrate respectively a top view and a side view of a possible arrangement of the support of FIG. 2.

The support 30 of the condenser 20 according to the invention can be folded up as a comb in order to occupy less space while allowing a sufficient evaporation/condensation surface. For example, with an exchange surface of 0.25 m², i.e. 12 sections of 10×20 cm² and an evaporation rate of 1 g/s, 300 g of water are condensed in 5 minutes.

The casing 10 of the cooking appliance can have, on a side wall for example, a box 27 containing the evaporator/condenser 20. An air flow A is provided in this box 27 in order to ensure the evaporation of the moistened surface of the evaporator 24. The evaporation surface 24 is exposed to an air flow by a small fan 28 which increases the rate of evaporation and therefore of cooling. In order to evaporate 1 gram of water per second, an air flow at 50° C. of 25 m³/h is necessary, a low-power fan, for example 0.5 W, is sufficient.

The operation of the cooling device according to the embodiment illustrated in FIGS. 2 to 4 will now be described.

At start-up, the evaporator 24 and the condenser 23 are at approximately 25° C. The fan is operating, for example automatically, when the cooking appliance is turned on. From the start of cooking, the condensation on the cold surface of the condenser 23 (at 25° C.) raises the temperature of the support 30 of the evaporator/condenser 20 while moistening the condensation surface 23 with the condensate. The surface of the evaporator 24 is thus immediately moistened by capillary transfer in the porous support 30.

The air flow A generated by the fan 28 on the evaporation surface 24 evaporates the water and cools this surface. This cooling is conducted through the support 30 to the condensation surface 23.

The evaporation takes place more rapidly as the evaporation surface 24 heats up. In fact, at 25° C., one litre of air takes away 0.03 litres of steam, while at 80° C., one litre of air takes away one litre of steam. When the flow of steam generated by the cooking is reduced, the temperature falls and a balance between the quantity of condensed water and that of evaporated water is constantly established. The temperature of the support 30 is adjusted as a function of the quantity of water evacuated by the air flow due to the saturated steam pressure in this air flow.

At the end of cooking, the temperature of the condenser 23 again approaches ambient temperature, which allows the inside of the cooking vat 11 and the lid 12 to be dried by transfer of the water condensed on the other walls of the appliance to the cooled condenser 23.

It can be advantageous to place a small brake which slows the descent of the cooking basket into the vat 11 in order to limit the very considerable initial release of steam and the large splashes of oil when the product to be cooked is plunged into the vat 11.

For safety reasons, it is preferable to provide a pressure relief valve in the cooking appliance. Thus, if due to external conditions, such as great humidity or excessive heat, the evaporator according to the invention is not able to sufficiently condense the cooking vapours, these vapours must be evacuated according to the standard vapour-filtering methods.

1. A cooking appliance (1) comprising:
a condenser (23) for the steam (V) generated by cooking;
a water evaporator (24) which is able to cool the condenser.

2. A cooking appliance according to claim 1, characterized in that it comprises a water container (26) which is able to moisten the evaporator (24).

3. A cooking appliance according to claim 1, characterized in that it comprises a condensation container (25).

4. A cooking appliance according to claim 1, characterized in that the evaporator (24) evaporates the water condensed by the condenser (23).

5. A cooking appliance according to claim 1, characterized in that it comprises a porous support (30), a first face (31) of the support comprising the condenser (23) and a second face (32) of the support comprising the evaporator (24).

6. A cooking appliance according to claims 5, characterized in that the porous support (30) is able to transport the water by capillary action from the first face (31) to the second face (32).

7. A cooking appliance according to claim 5, characterized in that the support (30) comprises a metal part.

8. A cooking appliance according to claim 5, characterized in that the metal part of the porous support is made of aluminium.

9. A cooking appliance according to claim 5, characterized in that the metal part of the porous support is made of sintered metal.

10. A cooking appliance according to claim 5, characterized in that the metal part of the porous support comprises cells constituted by microperforations.

11. A cooking appliance according to claim 5, characterized in that the support (30) comprises a metal grid.

12. A looking appliance according to claim 5, characterized in that the support (30) comprises a hydrophilic porous layer.

13. A cooking appliance according to claim 1, characterized in that it also comprises a fan (28).

14. A cooking appliance according to claim 1, characterized in that it also comprises a pressure relief valve.

15. A cooking appliance according to claim 1, characterized in that it also comprises a filter.
